(19) United States
(12) Patent Application Publication
(10) Pub. No.: US 2026/0155127 A1
(43) Pub. Date: Jun. 4, 2026

(54) ADJUSTABLE MARINE SONAR TRANSDUCER POLE

(71) Applicant: Vexilar, LLC, Bloomington, MN (US)

(72) Inventors: Joseph Anthony Kane, Bloomington, MN (US); Jacob Thomas Pennaz, Anoka, MN (US); Maxwell Robert Jablonski, Minneapolis, MN (US); Robert Anthony Jablonski, Mendota Heights, MN (US)

(21) Appl. No.: 19/399,042

(22) Filed: Nov. 24, 2025

Related U.S. Application Data
(60) Provisional application No. 63/727,401, filed on Dec. 3, 2024.

(51) Int. Cl. G10K 11/00; G01S 7/521; G01S 15/96

(52) U.S. Cl. CPC G10K 11/006; G01S 7/521; G01S 15/96

(57) ABSTRACT

An adjustable sonar transducer pole is disclosed for use as amount for a live sonar transducer. In one or more arrangements, the adjustable sonar transducer pole can be mounted to a boat or a set of legs which span an ice hole for use while ice fishing. In one or more arrangements, the adjustable sonar transducer pole includes a pole, a control arm operably connected to an upper end of the pole, an actuator operably connected to the control arm, a mount operably connected to a lower end of the pole, and a cable extending through the pole from the actuator to the transducer mount assembly. In one or more arrangements, the actuator and control arm are configured to permit a transducer head mounted on the transducer pole to be repositioned using one hand to be rotated vertically and at the same time rotated 360 degrees about a vertical axis.

### CROSS-REFERENCE TO RELATED APPLICATIONS

This application claims priority to U.S. Provisional Application 63/727,401, tiled “ADJUSTABLE MARINE SONAR TRANSDUCER POLE”, and filed on Dec. 3, 2024, the entirety of which is hereby incorporated by reference herein, including any figures, tables, drawings, or other information.

### FIELD OF THE DISCLOSURE

This disclosure relates generally to sonar devices. More specifically and without limitation, this disclosure relates to sonar devices for marine applications.

### OVERVIEW OF THE DISCLOSURE

Anglers use sonar devices to increase their chances of finding and catching fish, with the latest trend being advanced “live” sonar devices that provide real-time views below the water's surface. Unlike previous generations of sonar devices, which only showed what was directly below the boat, live sonar can look out in whatever direction the transducer is facing, from a few feet to hundreds of feet. These devices make it easier for anglers to locate fish, monitor fish activity, learn about fish behavior, and monitor their lure/bait.

Generally speaking, sonar transducers broadcast pulses of sound with a spectrum distributed across a field of view. In some sonar transducers, transmitted pulses are diffracted to transmit a spectrum of different frequencies across a beam field of view. Based on transmit times, intensity and/or frequency of reflected pulse signals, sonar images are interpolated by a processing unit of the transducer to generate a sonar image. Some sonar transducers have multiple beams configured to transmits pulses in different directions.

FIGS. 18A-18C show an example single bar sonar transducer configured to transmit a sonar beam having two lobes, each providing approximately 35 degree field of view, separated from one another by approximately 70 degrees. FIGS. 19A-19C show another example of a three-bar sonar transducer configured to transmit a plurality of sonar beams to effectively provide a 135 degree field of view. Each transducer bar transmits a sonar beam having two lobes, each providing approximately 22.5 degree field of view, separated from one another by approximately 45 degrees. The bar transducers are positioned such that the approximately 22.5 degree beams are adjacent to one another to effectively provide approximately a 135 degree field of view. However, the arrangements are not so limited to these example sonar transducer arrangements. Rather, it is contemplated that the disclosed arrangements may be adapted for use with various sonar transducers having any number of beams and/or field of view.

For additional information on sonar transducer systems, reference may be made to U.S. Pat. No. 8,811,120, titled “SYSTEMS AND METHODS IMPLEMENTING FREQUENCY-STEERED ACOUSTIC ARRAYS FOR 2D AND 3D IMAGING” and issued Aug. 19, 2014, which is hereby fully incorporated by reference herein.

Depending on the orientation of a sonar transducer, different field of views of sonar imaging are provided. However, current live sonar systems are limited in that the transducer is mounted on a transducer pole at a fixed angle. In these systems, viewing is limited to the field of view captured by the transducer. In current sonar transducer systems, vertical repositioning of the sonar transducer is generally achieved by removing the pole and attached transducer from the water and manually loosening a fastener that fixes the transducer to the pole, manually rotating the transducer to a new position, tightening the fastener to lock the transducer in position, and reinstalling the pole and transducer in the water. This is a time and labor intensive process and cannot be performed easily on the fly to adapt to different situations and/or changing conditions.

For the reasons stated above, and for other reasons stated below which will become apparent to those skilled in the art upon reading and understanding the disclosure, there is a need in the art for sonar transducer pole that improves upon the state of the art.

Thus it is an object of at least one embodiment of the disclosure is to provide a transducer pole system configured to adjust an orientation of a sonar transducer in situ without removing the transducer pole system and transducer from the water.

It is another object of at least one embodiment of the disclosure is to provide a transducer pole system configured to provide an improved field of view of the water under and surrounding the mounting position of the pole.

It is yet another object of at least one embodiment of the disclosure is to provide a transducer pole system configured to adjust an orientation of a sonar transducer during operation to better utilize the capabilities and functionality of live sonar.

It is another object of at least one embodiment of the disclosure is to provide a transducer pole system configured to facilitate rotation of a sonar transducer about a first axis longitudinal to the transducer pole as well as about a second axis positioned at an angle to the first axis (e.g., transverse axis to the transducer pole).

It is yet another object of at least one embodiment of the disclosure is to provide a transducer pole system configured to permit a user to rotate a sonar transducer vertically in defined positions to see various sections of the water under the pole mounting location and also permit a user to rotate the sonar transducer independently and concurrently a full 360 degrees around the longitudinal axis of the pole.

It is another object of at least one embodiment of the disclosure is to provide a transducer pole system configured to reposition a sonar transducer about multiple axis using controls operated via a single hand.

This disclosure is directed at making it easier for anglers to change the vertical rotation and to concurrently rotate the sonar transducer independently a full 360 degrees around the longitudinal axis of the pole and leverage the capabilities of live sonar devices.

### BRIEF DESCRIPTION OF THE FIGURES

FIG. 1 shows an upper rear side perspective view of an adjustable sonar transducer pole, in accordance with one or more arrangements.

FIG. 2 shows an exploded side view of an adjustable sonar transducer pole, in accordance with one or more arrangements.

FIG. 3 shows a partial view of an adjustable sonar transducer pole, in accordance with one or more arrangements; the view showing an upper end of the transducer pole, control arm and actuator.

FIG. 4 shows a partial view of an adjustable sonar transducer pole, in accordance with one or more arrangements; the view showing a close up view of the actuator and handle.

FIG. 5 shows a partial view of an adjustable sonar transducer pole, in accordance with one or more arrangements; the view showing a close up view of the actuator.

FIG. 6 shows a perspective view of a lower end of an adjustable sonar transducer pole, in accordance with one or more arrangements; the view showing a sonar transducer mounted on the adjustable sonar transducer pole.

FIG. 7 shows a side view of a lower end of an adjustable sonar transducer pole, in accordance with one or more arrangements; the view showing a sonar transducer mounted on the adjustable sonar transducer pole.

FIG. 8 shows a rear view of a lower end of an adjustable sonar transducer pole, in accordance with one or more arrangements; the view showing a sonar transducer head mounted on a transducer mount assembly of the adjustable sonar transducer pole.

FIG. 9 shows a perspective view of a lower end of an adjustable sonar transducer pole, in accordance with one or more arrangements; the view showing a close up view of a transducer mount assembly of the adjustable sonar transducer pole.

FIG. 10 shows an exploded upper front side perspective view of an adjustable sonar transducer pole with a telescoping pole, in accordance with one or more arrangements; the view showing the telescoping pole collapsed.

FIG. 11 shows an upper front side perspective view of an adjustable sonar transducer pole with a telescoping pole, in accordance with one or more arrangements; the view showing the telescoping pole extended.

FIG. 12 shows a side view of an adjustable sonar transducer pole with a telescoping pole, in accordance with one or more arrangements; the view showing the telescoping pole extended.

FIG. 13 shows a front view of an adjustable sonar transducer pole with a telescoping pole, in accordance with one or more arrangements; the view showing the telescoping pole extended.

FIG. 14 shows a top view of an adjustable sonar transducer pole with a telescoping pole, in accordance with one or more arrangements.

FIG. 15 shows an upper front side perspective view of an adjustable sonar transducer pole with a telescoping pole, in accordance with one or more arrangements; the view showing the telescoping pole collapsed.

FIG. 16 shows a side view of an adjustable sonar transducer pole with a telescoping pole, in accordance with one or more arrangements; the view showing the telescoping pole collapsed.

FIG. 17 shows a front view of an adjustable sonar transducer pole with a telescoping pole, in accordance with one or more arrangements; the view showing the telescoping pole collapsed.

FIG. 18A shows a side view of a sonar transducer, in accordance with one or more arrangements; the view showing the sonar transducer rotated rearward.

FIG. 18B shows a side view of a sonar transducer, in accordance with one or more arrangements; the view showing the sonar transducer oriented for sonar imaging downward.

FIG. 18C shows a side view of a sonar transducer, in accordance with one or more arrangements; the view showing the sonar transducer rotated forward.

FIG. 19A shows a side view of a sonar transducer, in accordance with one or more arrangements; the view showing the sonar transducer oriented for sonar imaging downward.

FIG. 19B shows a side view of a sonar transducer, in accordance with one or more arrangements; the view showing the sonar transducer rotated forward.

### SUMMARY OF THE DISCLOSURE

An adjustable sonar transducer pole is disclosed for use as a mount for a live sonar transducer. In one or more arrangements, the adjustable sonar transducer pole can be mounted to a boat or a set of legs which span an ice hole for use while ice fishing. In one or more arrangements, the adjustable sonar transducer pole provides the user with the ability to rotate the transducer vertically in defined positions to see various sections of the water under the pole mounting location and at the same time can be rotated independently and concurrently a full 360 degrees around the longitudinal axis of the pole.

In one or more arrangements, the adjustable sonar transducer pole includes a pole, a control arm operably connected to an upper end of the pole, an actuator operably connected to the control arm, a rotatable mount operably connected a lower end of the pole, and a cable extending through the pole from the actuator to the transducer mount assembly. Movement of the actuator actuates the cable to rotate the transducer mount assembly. In one or more arrangements, vertical rotation can be achieved using an actuator positioned on a control arm of the adjustable sonar transducer pole, which shortens or lengthens a cable which runs down the inside length of the pole and attaches to a transducer mount assembly. The transducer is attached to this transducer mount assembly so that by rotating the mechanism on the pole handle, the user can rotate the transducer vertically and rotate the entire pole longitudinally (e.g., with a single hand) and without needing to remove the transducer or pole from the water.

### DETAILED DESCRIPTION OF THE DISCLOSURE

In the following detailed description of the embodiments, reference is made to the accompanying drawings which form a part hereof, and in which is shown by way of illustration specific embodiments in which the disclosure may be practiced. The embodiments of the present disclosure described below are not intended to be exhaustive or to limit the disclosure to the precise forms in the following detailed description. Rather, the embodiments are chosen and described so that others skilled in the art may appreciate and understand the principles and practices of the present disclosure. It will be understood by those skilled in the art that various changes in form and details may be made without departing from the principles and scope of the invention. It is intended to cover various modifications and similar arrangements and procedures, and the scope of the appended claims therefore should be accorded the broadest interpretation so as to encompass all such modifications and similar arrangements and procedures. For instance, although aspects and features may be illustrated in or described with reference to certain figures or embodiments, it will be appreciated that features from one figure or embodiment may be combined with features of another figure or embodiment even though the combination is not explicitly shown or explicitly described as a combination. In the depicted embodiments, like reference numbers refer to like elements throughout the various drawings.

It should be understood that any advantages and/or improvements discussed herein may not be provided by various disclosed embodiments, or implementations thereof. The contemplated embodiments are not so limited and should not be interpreted as being restricted to embodiments which provide such advantages or improvements. Similarly, it should be understood that various embodiments may not address all or any objects of the disclosure or objects of the invention that may be described herein. The contemplated embodiments are not so limited and should not be interpreted as being restricted to embodiments which address such objects of the disclosure or invention. Furthermore, although some disclosed embodiments may be described relative to specific materials, embodiments are not limited to the specific materials or apparatuses but only to their specific characteristics and capabilities and other materials and apparatuses can be substituted as is well understood by those skilled in the art in view of the present disclosure.

It is to be understood that the terms such as “left, right, top, bottom, front, back, side, height, length, width, upper, lower, interior, exterior, inner, outer, and the like as may be used herein, merely describe points of reference and do not limit the present invention to any particular orientation or configuration.

As used herein, the term “or” includes one or more of the associated listed items, such that “A or B” means “either A or B”. As used herein, the term “and” includes all combinations of one or more of the associated listed items, such that “A and B” means “A as well as B.” The use of “and/or” includes all combinations of one or more of the associated listed items, such that “A and/or B” includes “A but not B,” “B but not A,” and “A as well as B,” unless it is clearly indicated that only a single item, subgroup of items, or all items are present. The use of “etc.” is defined as “et cetera” and indicates the inclusion of all other elements belonging to the same group of the preceding items, in any “and/or” combination(s).

As used herein, the singular forms “a,” “an,” and “the” are intended to include both the singular and plural forms, unless the language explicitly indicates otherwise. Indefinite articles like “a” and “an” introduce or refer to any modified term, both previously-introduced and not, while definite articles like “the” refer to a same previously-introduced term; as such, it is understood that “a” or “an” modify items that are permitted to be previously-introduced or new, while definite articles modify an item that is the same as immediately previously presented. It will be further understood that the terms “comprises,” “comprising,” “includes,” and/or “including,” when used herein, specify the presence of stated features, characteristics, steps, operations, elements, and/or components, but do not themselves preclude the presence or addition of one or more other features, characteristics, steps, operations, elements, components, and/or groups thereof, unless expressly indicated otherwise. For example, if an embodiment of a system is described as comprising an article, it is understood the system is not limited to a single instance of the article unless expressly indicated otherwise, even if elsewhere another embodiment of the system is described as comprising a plurality of articles.

It will be understood that when an element is referred to as being “connected,” “coupled,” “mated,” “attached,” “fixed,” etc. to another element, it can be directly connected to the other element, and/or intervening elements may be present. In contrast, when an element is referred to as being “directly connected,” “directly coupled,” “directly engaged” etc. to another element, there are no intervening elements present. Other words used to describe the relationship between elements should be interpreted in a like fashion (e.g., “between” versus “directly between,” “adjacent” versus “directly adjacent,” “engaged” versus “directly engaged,” etc.). Similarly, a term such as “operatively”, such as when used as “operatively connected” or “operatively engaged” is to be interpreted as connected or engaged, respectively, in any manner that facilitates operation, which may include being directly connected, indirectly connected, electronically connected, wirelessly connected or connected by any other manner, method or means that facilitates desired operation. Similarly, a term such as “communicatively connected” includes all variations of information exchange and routing between two electronic devices, including intermediary devices, networks, etc., connected wirelessly or not. Similarly, “connected” or other similar language particularly for electronic components is intended to mean connected by any means, either directly or indirectly, wired and/or wirelessly, such that electricity and/or information may be transmitted between the components.

It will be understood that, although the ordinal terms “first,” “second,” etc. may be used herein to describe various elements, these elements should not be limited to any order by these terms unless specifically stated as such. These terms are used only to distinguish one element from another; where there are “second” or higher ordinals, there merely must be a number of elements, without necessarily any difference or other relationship. For example, a first element could be termed a second element, and, similarly, a second element could be termed a first element, without departing from the scope of example embodiments or methods.

Similarly, the structures and operations discussed herein may occur out of the order described and/or noted in the figures. For example, two operations and/or figures shown in succession may in fact be executed concurrently or may sometimes be executed in the reverse order, depending upon the functionality/acts involved. Similarly, individual operations within example methods described below may be executed repetitively, individually or sequentially, to provide looping or other series of operations aside from single operations described below. It should be presumed that any embodiment or method having features and functionality described below, in any workable combination, falls within the scope of example embodiments.

As used herein, various disclosed embodiments may be primarily described in the context of sonar devices for marine applications. However, the embodiments are not so limited. It is appreciated that the embodiments may be adapted for use in various other applications, which may be improved by the disclosed structures, arrangements and/or methods. The system is merely shown and described as being used in the context of sonar devices for marine applications for ease of description and as one of countless examples.

### System 100

With reference to the figures, an adjustable sonar transducer pole system 100 (or transducer pole 100 or simply system 100) is presented. The transducer pole 100 is formed of any suitable size, shape and design and is configured to facilitate positioning of a sonar transducer for use in marine applications. In the arrangement shown, as one example, system 100 includes a pole 110, a control arm 130, and a transducer mount assembly 150, among other components.

The adjustable sonar transducer pole 100 can be coupled to a structure, such as the side of a boat and/or a set of legs, which allows the transducer head 290 to be positioned below water to capture sonar images in marine applications. In these examples, the adjustable sonar transducer pole 100 can allow for: (i) rotating a transducer head 290 about a longitudinal axis of the pole 110 (e.g., by rotating control arm 130 about an axis of pole 110); and (ii) pivoting the transducer head 290 at various angles relative to the pole 110 (e.g., using an actuator 138 of control arm 130).

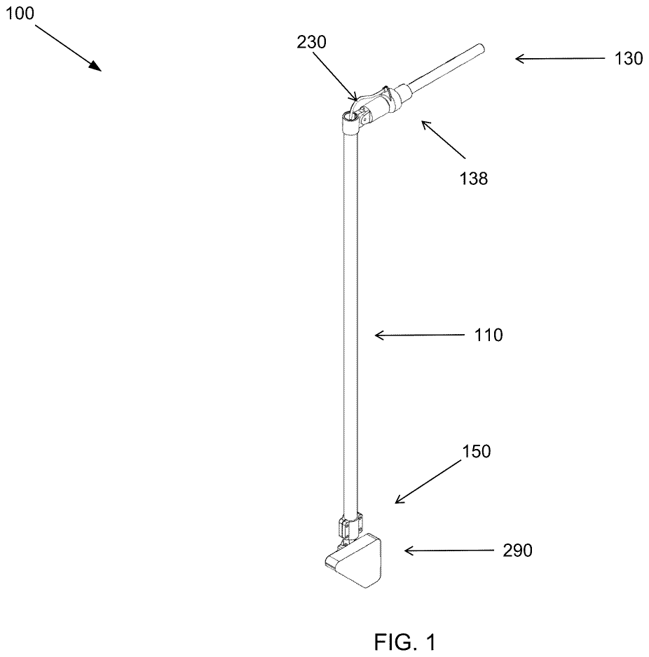

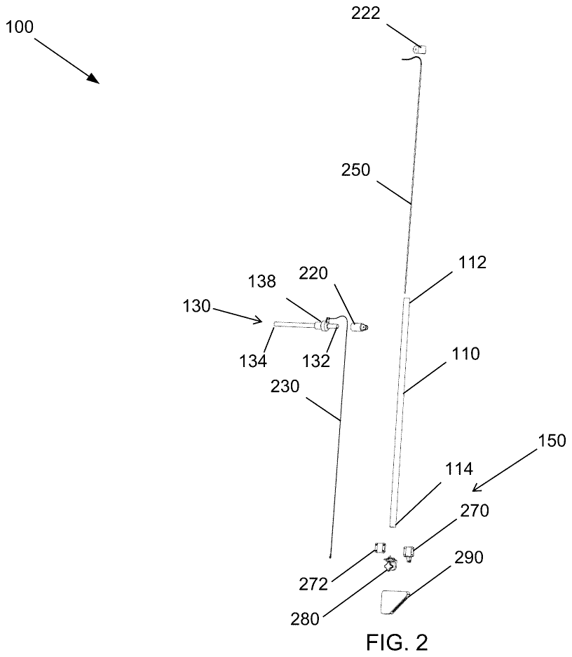

FIGS. 1-2 show an example adjustable sonar transducer pole 100, in accordance with one or more arrangements. In this example, the adjustable sonar transducer pole 100 includes a pole 110 running from an actuator 138 to transducer mount assembly 150 holding a transducer head 290. The disclosed adjustable sonar transducer pole 100 can be assembled to maintain proper functionality for multiple mechanical operations, including the operation of actuator 138, the handle's ability to swivel up and down, and/or the locking mechanism. Additionally, in one or more arrangements, the system provides routing of both the indexer cable 230 and electronics wire (not shown) through the tube 110 while maintaining proper tension and functionality in wet and/or ice environment, as these components must operate reliably in a marine environment.

### Pole 110

Pole 110 is formed of any suitable size, shape and design and is configured to operably connect control arm 130 and transducer mount assembly 150 and facilitate positioning of a sonar transducer 290 for marine applications.

In the arrangement shown, as one example, pole 110 is a cylindrical shaped tube extending from an upper end 112 to a lower end 114. However the arrangements are not so limited. Rather, it is contemplated that in some various arrangements system 100 may be adapted to use a pole 110 having various other elongated shapes and/or structures. For example, in some arrangements, pole 110 may be a tube having a non-cylindrical shape (square, triangular, etc.). As another example, in some arrangements, pole 110 may be formed using an elongated track or channel (e.g., a c-channel). As yet another example, in some arrangements pole 110 may be a solid rod.

### Control Arm 130

Control Arm 130 is formed of any suitable size, shape and design and is configured to facilitate positioning of sonar transducer 290 (e.g., by rotating pole 110 and/or using one or more actuators of control arm). In the arrangement shown, control arm 130 has an elongated shape extending from an inward end 132, where control arm 130 is operably connected with upper end 112 of pole 110, to an outward end 134. In one or more arrangements, control arm 130 is connected to upper end 112 of pole 110 by one or more pivot mounts 220 and 222. Pivot mounts 220 and 222 allow the actuator 138 to be coupled to an upper end 112 of pole 110 out of the water while permitting the angle of control arm 130 relative to pole 110 to be adjusted. Alternatively, in some arrangements, control arm 130 may be connected to upper end 112 of pole 110 at a fixed non-adjustable angle. In one or more arrangements a handle 136 or handgrip is positioned on the outward end 134. In one or more arrangements, an actuator 138 is positioned on control arm 130 proximate to handle 136.

### Actuator 138

Actuator 138 is formed of any suitable size, shape and design and is configured to facilitate repositioning of rotatable sonar transducer around a defined pivot point to reposition the sonar arrays to view various sections of the available field of view. In one or more arrangements, as is shown, actuator 138 is configured to facilitate such repositioning by pushing/pulling on a cable or other suitable linkage as described below 230 that is operably connected with transducer mount assembly 130 transducer mount assembly 130. Various types of actuators 138 may be utilized to move indexer cable 230 including but not limited to, for example, various indexed or friction shifters such as twist grip shifters, trigger shifters, thumb shifters, lever or stem shifters, knobs, sliders, or any other type of shifter or method or device for physical actuation.

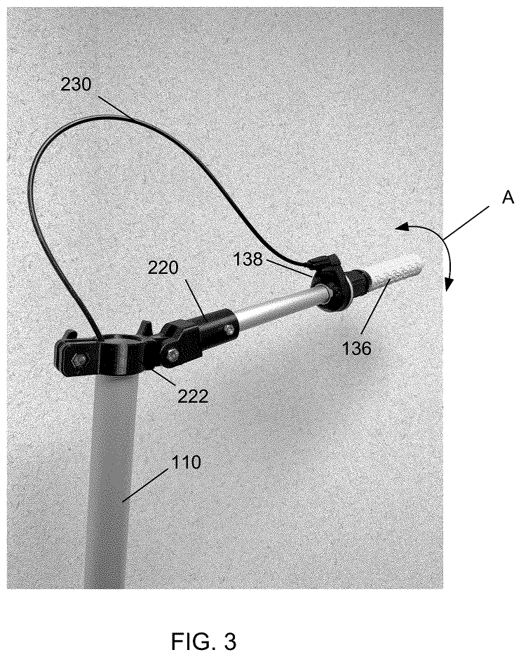

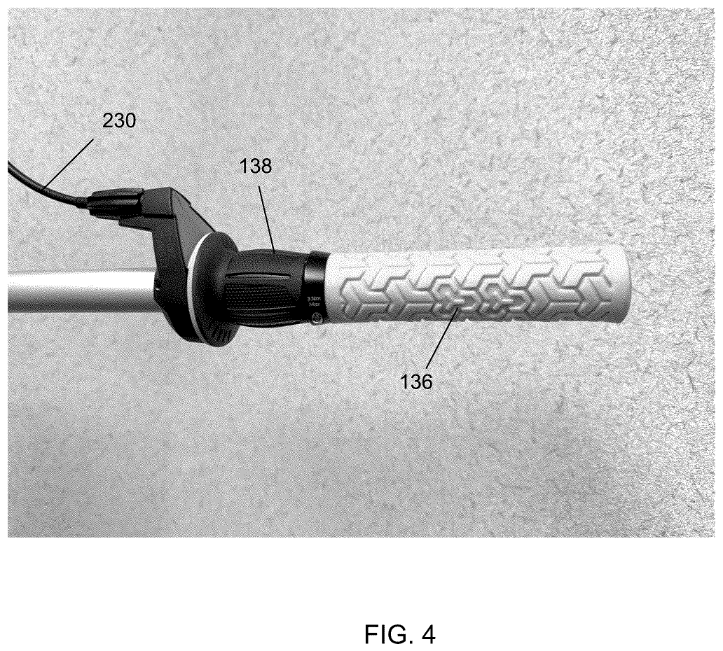

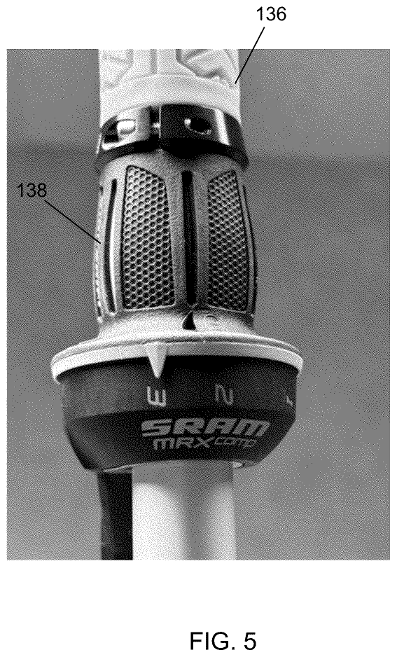

FIGS. 3-5 show an example actuator 138 in more detail. In this example, the actuator 138 is a component positioned on control arm 130 at the upper end 132 of the adjustable sonar transducer pole 100 that allows manual control of the orientation of the transducer head 290. The actuator 138 contains a mechanism that, when rotated in directions A, operates the indexer cable 230 running through pole 110 to control the orientation of the transducer head 290, as described further below. This actuator 138 allows for single-handed operation to control both the vertical rotation of the transducer through defined positions and the full 360-degree rotation of the entire pole around its longitudinal axis. This allows the user's other hand to remain available for other tasks such as holding a fishing rod, steering the boat, and/or operating a head unit.

In one example, the actuator 138 is a SRAM 3 grip shifter from SRAM LLC of Chicago, Illinois. This example actuator 138 is a bicycle-style shifter component that enables precise rotational control of the transducer head 290. The actuator 138 can include internal components that allow for indexed rotational movement. For instance, the actuator 138 can define a plurality of indexed positions for movement of the transducer head 290, as provided further below.

In this example, actuator 138 is combined with a hand grip 136 that provides ergonomic control of the actuator 138. In one or more arrangements, the hand grip 136 is a Bontrager bike grip, although other configurations are possible.

In one or more arrangements, actuator 138 is coupled to pole 110 by the pivot mounts 220 and 222. The pivot mounts 220 and 222 allow the actuator 138 to swivel up and down and lock into place at desired positions. Many other configurations are possible.

However, the arrangements are not so limited to cable based actuators. Rather, it is envisioned that in some various arrangements actuator 138 may be mechanically connected with transducer mount assembly 150 via various mechanisms and/or structures including but not limited to, for example, cables, ropes, chains, screws, shafts, rods, ratches, gears, and/or linkages. Many alternative configurations are possible. For instance, an alternative screw-based system could be used to adjust the transducer orientation instead of the cable-driven system. Further, a ratcheting rod mechanism could provide indexed positions for the transducer orientation. In yet another example, a set of planetary gears could be employed to control the transducer movement.

Alternatively, in lieu of a mechanical connection, in some arrangements actuator 138 may be electronically or wirelessly connected with transducer mount assembly 150 and configured to adjust position of sonar transducer 290 by communicating voltages or control signals to transducer mount assembly 150.

### Transducer Mount Assembly 150

Transducer mount assembly 150 is formed of any suitable size, shape and design and is configured to operably connect sonar transducer 290 with lower end 114 of pole 110 and facilitate repositioning sonar transducer 290 by pivoting the transducer around one or more defined pivot point that repositions the sonar arrays of the transducer to view different portions of the available field of view. in response to movement of indexing cable 320 or other control by actuator 138.

In one or more arrangements, as is shown, transducer mount assembly 150 includes a first mount 270/272, a second rotational mount 280 pivotally connected to mount 270, and a bias member 284, among other components. In this example, mount 270/272 is configured to operably connect with lower end 114 of pole 110 and rotational mount 280 is configured to operably connect with transducer head 290. The hinged connection between mounts 270/272 and 280 are connected together at a pivot point to allow the rotational mount 280 to be coupled to a lower end 114 of the pole 110 under the water. In this example arrangement, an indexer cable 230 runs from the actuator 138, through pole 110, and to the rotational mount 280 and/or transducer head to move the transducer head 290 as described below.

In one or more arrangements, an electronics wire 250 (not shown) runs through the pole 110 and to the transducer head 290 to allow data from the transducer head 290 to be provided and/or external power to be provided to transducer head 290.

While some arrangements may be primary described with reference to indexer cable 230 and/or electronics wire 250 being routed through pole 110, the arrangements are not so limited. Rather, it is contemplated that in some arrangements indexer cable 230 and/or electronics wire 250 may be routed outside of pole 110 from actuator 138 to the rotational mount 280 and/or transducer head 290.

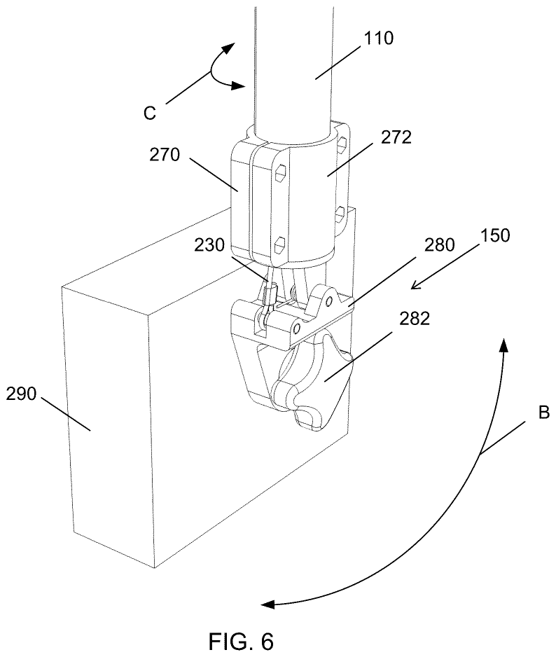

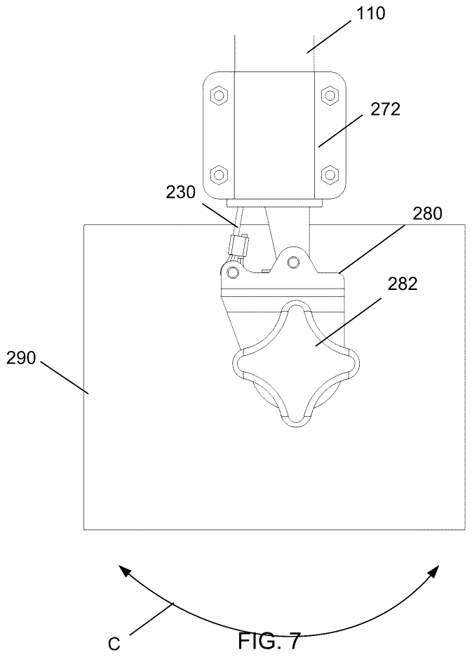

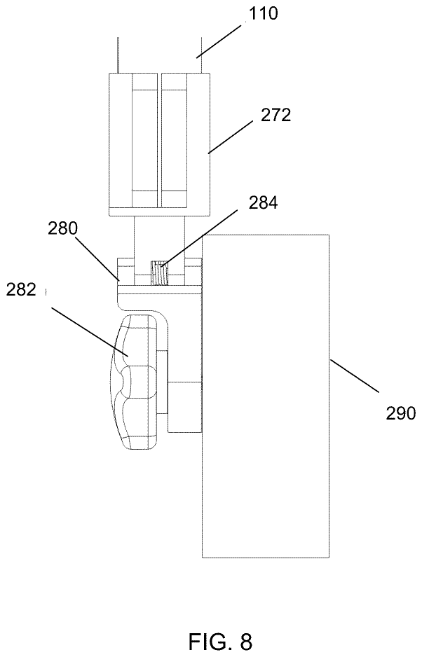

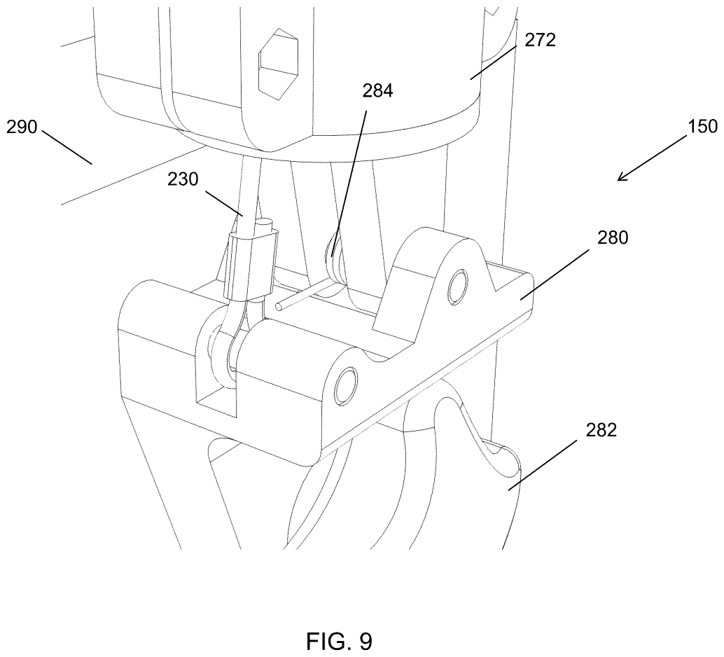

Referring now to FIGS. 6-9, in this example arrangement, the actuator 138 generally functions to convert rotational movement in the directions A into actuation of the indexer cable 230 by shortening or lengthening the indexer cable 230 that runs down the inside length of the pole 110. This actuation of the actuator 138 thereby controls the orientation of the transducer head 290. This provides indexed positions that allow for predetermined increments of rotation across specific degrees to show portions of 180 degrees for the transducer head 290. More specifically, the transducer head 290 is rotationally coupled to the pole 110 by the rotational mount 280. The rotational mount 280 is, in turn, rotationally coupled to the mount 272 to allow the rotational mount 280 to rotate in directions B.

In this example, a bolt 282 extends through the rotational mount 280 to fix the transducer head 290 to rotational mount 280. However, the arrangements are not so limited. Rather, it is contemplated that in some various arrangements rotational mount 280 may be configured to use various additional or alternative method and/or means to facilitate connection between transducer head 290 and rotational mount 280 including but not limited to, for example, screws, bolts, or other fasteners, clamps, snaps, lock channels, and/or any other method or means for connecting. Further yet, in various different arrangements, the system can be designed to accommodate transducer heads of various sizes and configurations. It is contemplated that various different mounting systems may be utilized for various boat configurations or ice fishing setups.

In this example arrangement, the indexer cable 230 is coupled to the rotational mount 280. As the actuator 138 is rotated by the user in the directions A, the indexer cable 230 is lengthened or shortened so as to move the rotational mount 280 and attached transducer head 290 in the directions B. In this manner, the transducer head 290 can be moved at angles up to 180 degrees relative to the longitudinal axis of the pole 110.

In one or more arrangements, as is shown, a bias member 284 is operably connected to rotational mount 280. Bias member 284 is formed of any suitable size, shape, and design and is configured to engage and apply a biasing force to the rotational mount 280 and/or transducer hear to facilitate return the rotational mount 280 and attached transducer head 290 to a “home” or “0” position when tension by the indexer cable 230 is released. In the arrangement shown, as one example bias member 284 is a compression spring. However, the arrangements are not so limited. Rather, it is contemplated that various different arrangements bias member 284 may utilize various types of springs (e.g., torsion spring, compression spring, extension spring, or any other type of spring), stretchable bands, compressible materials, pneumatics, motors, and/or other method or means to apply a bias force.

In one or more arrangements, the actuator 138 is an indexed type actuator configured to define a plurality of discrete positions, such as 0 degrees, 30 degrees, 60 degrees, 90 degrees, etc. In one instance, the actuator 138 can be labeled for each position so the relative location of the actuator 138 provides a visual indication of the position of the transducer head 290. In other examples, the actuator 138 can define a set of positions between 0 and 180 degrees or more. The index type actuator can provide specific predetermined increments of rotation for transducer viewing angles. In one or more arrangements, the system can incorporate precise detents and wedges to maintain consistent indexed positions while simultaneously allowing for both vertical rotation control and unrestricted 360-degree pole rotation.

Alternatively, in some arrangements, actuator 138 may be a friction type actuator configured to move transducer head 290 to an infinite number of difference positions. Other configurations are also possible.

In one or more arrangements, as is shown, the actuator 138 can be used to rotate about the longitudinal axis of the pole 110 in directions C to change the orientation of the transducer head 290. In this example arrangement, the adjustable sonar transducer pole 100 therefore enables single-handed operation to control the vertical rotation of the transducer through defined positions while also allowing unrestricted 360-degree rotation of the entire pole around its longitudinal axis.

In one or more arrangements, transducer mount assembly 150 may be weather-proofed for marine use. The connection points between the various components can maintain water resistance while allowing proper mechanical function.

While some arrangements may be primary described with reference to a transducer mount assembly 150 having a first mount 270/272 and a second rotational mount 280 pivotally connected to each other to facilitate rotation of a transducer 290, the arrangements are not so limited. Rather, it is contemplated that various alternative arrangements may be used to facilitate rotation of a transducer 290. As one alternative example. in one or more arrangements transducer 290 may include a pivoting section pivotally connected to a main body of the transducer 290. The pivoting section may be configured to connect with a fixed or non-rotating transducer mount assembly 150. That is, in some arrangements, transducer 290 may by configured to pivot while transducer mount assembly 150 remains stationary. In such an arrangement, indexer cable 230 may be connected to the main body or other portion of the transducer 290 to facilitate rotation of the transducer relative to the pivoting section and/or transducer mount assembly 150.

### In Operation

One or more arrangements may provide various advantages by enabling seamless adjustment of the transducer orientation without removing the pole from the water. For instance, the design allows single-handed operation to control both vertical rotation (e.g., through defined index positions) and unrestricted 360-degree rotation around the pole's longitudinal axis (e.g., by lateral movement of outward end 134 of control arm 130), providing anglers with a greater field of view of the water under and surrounding the mounting position. This enhanced functionality makes it easier for anglers to leverage all the capabilities of their live sonar devices, allowing them to efficiently locate fish, monitor fish activity, learn about fish behavior, and track their lure/bait without the time-consuming process of manually reorienting the transducer.

In arrangements having an indexed actuator 138, the indexing mechanism ensures precise and repeatable transducer orientations, while the integrated cable system maintains reliable operation in marine environments. The ability to simultaneously control both vertical and rotational movements using control arm 130 and actuator 138 with a single hand represents a significant improvement in usability compared to existing designs that require removal from the water and manual repositioning of the transducer and/or multiple control inputs. Additionally, the system's compatibility with various transducer types and potential for automated control features provides flexibility for different user preferences and future technological adaptations.

### Not Limited to the Disclosed Methods of Actuation

While the arrangements may be primarily described with reference to hand based operation of control arm 130 and actuator(s), the arrangements are not so limited. Rather, it is contemplated that in some various arrangements, adjustable sonar transducer pole 100 may be adapted to use various additional or alternative controls or methods to reposition sonar transducers including but not limited to, for example, levers, wheels, knobs, sliders, foot peddles, shifters, buttons, touchscreens, and/or any other control mechanism or interface. For example, in some arrangements, a foot pedal control system may be used to adjust transducer orientation vertical and/or horizontal positioning. As another example, a hand-operated lever system could control vertical and horizontal movements, along with universal joints with control links to provide manual orientation control. The mechanism could be designed to move up and down about an axis. An indexed cable drive system could be implemented with position indicators. Such alternatives provide different approaches to achieving a similar capability of adjusting transducer orientation while maintaining the ability to see where the transducer is positioned. In yet some other arrangements, automated control of the position could be provided by means of motors or other actuators. For instance, a system could be configured for remote switching of modes via a screen interface. This could provide an automatic actuation of the indexing mechanism and could automatically switch modes when position is changed using a gyro sensor on the transducers.

### Alternative Arrangement

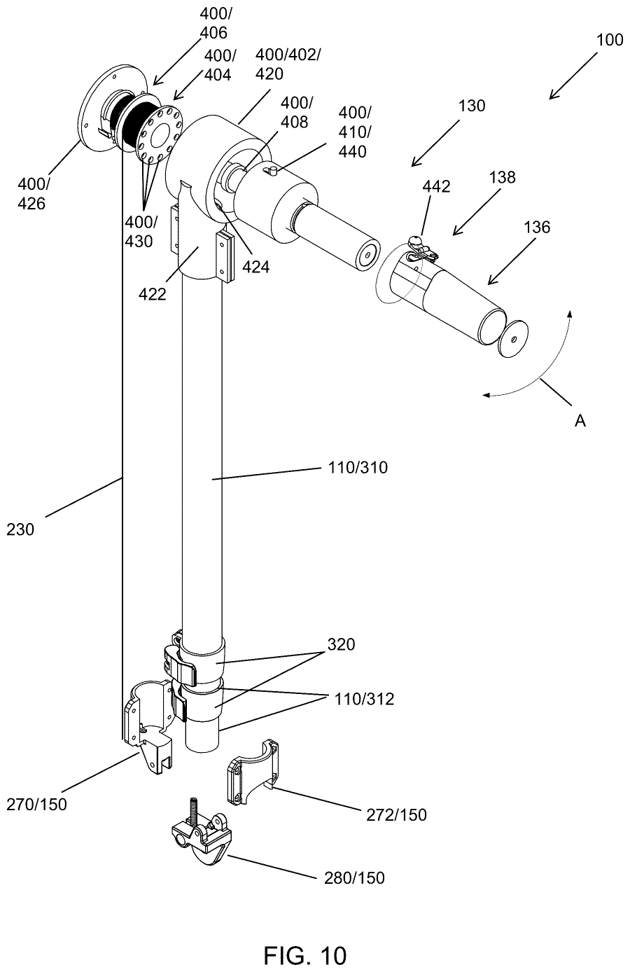

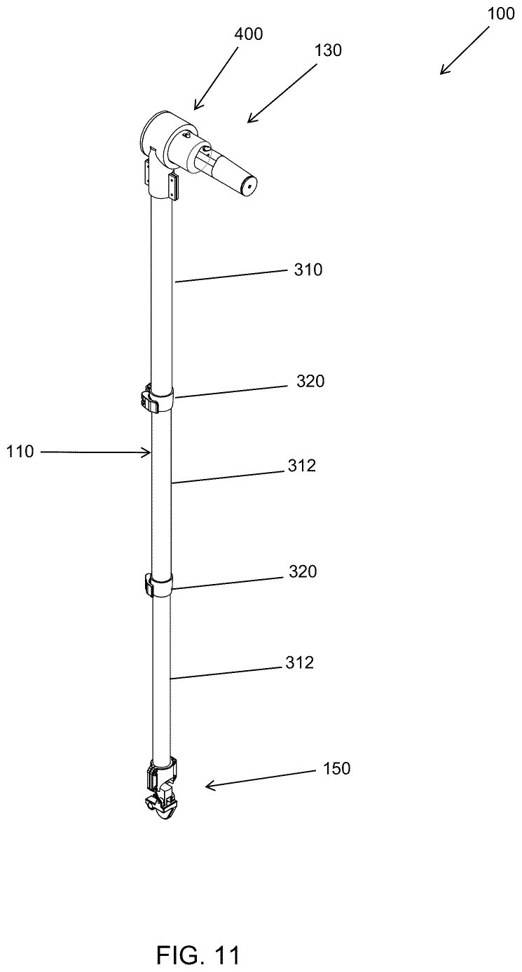

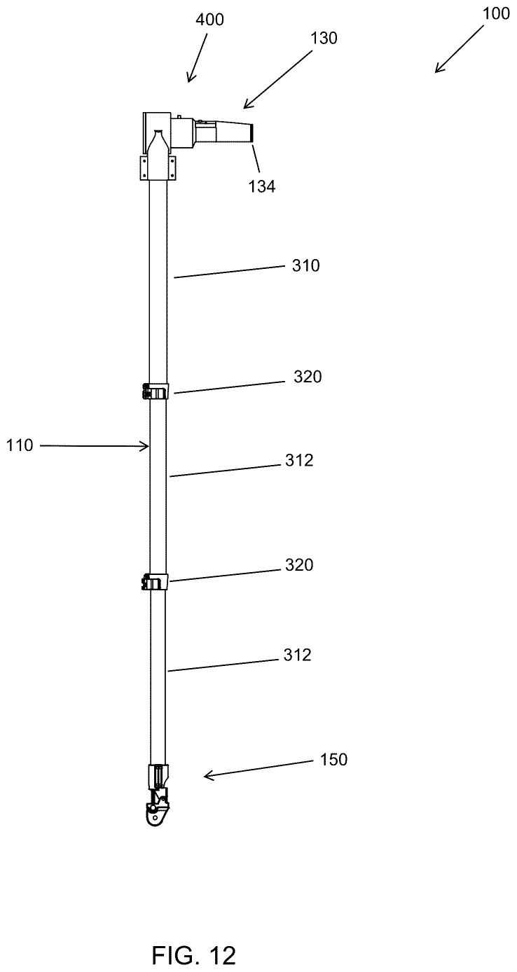

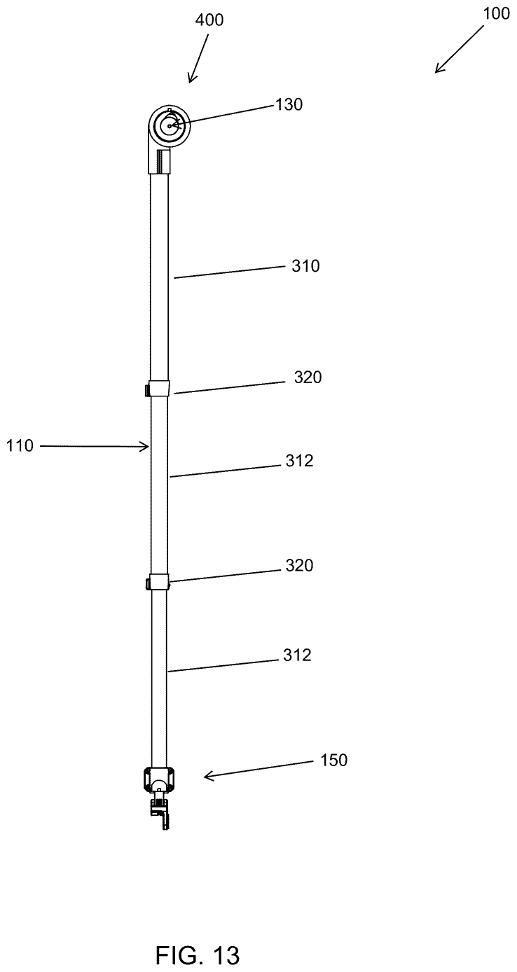

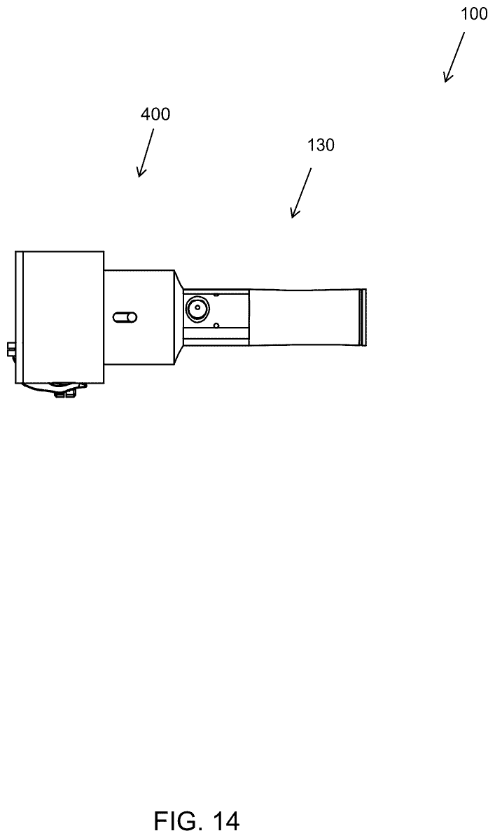

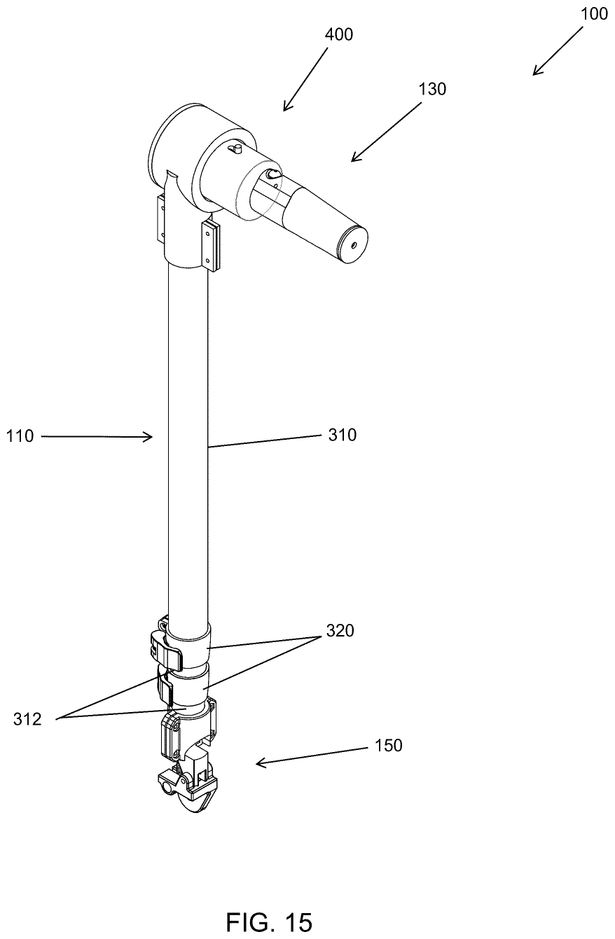

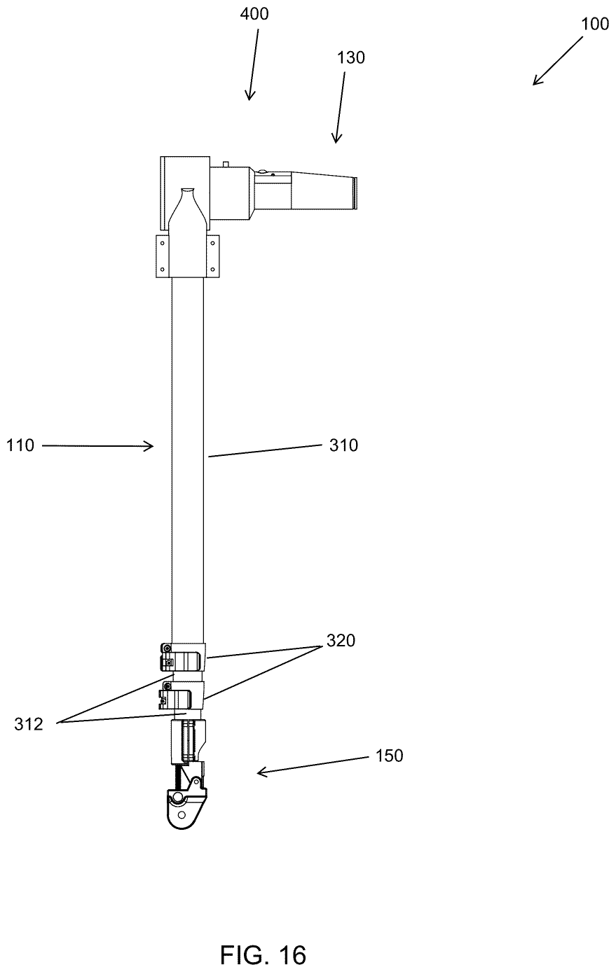

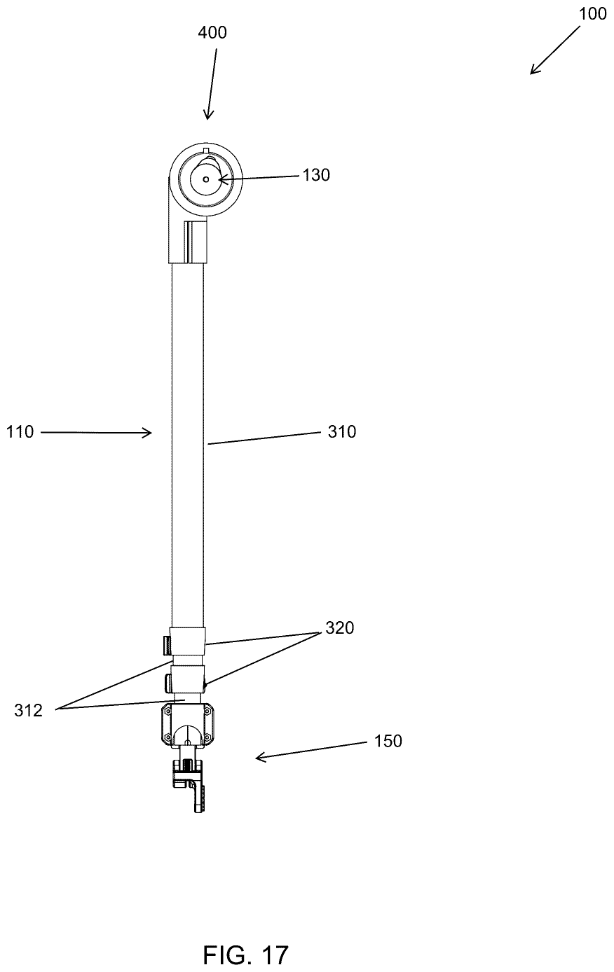

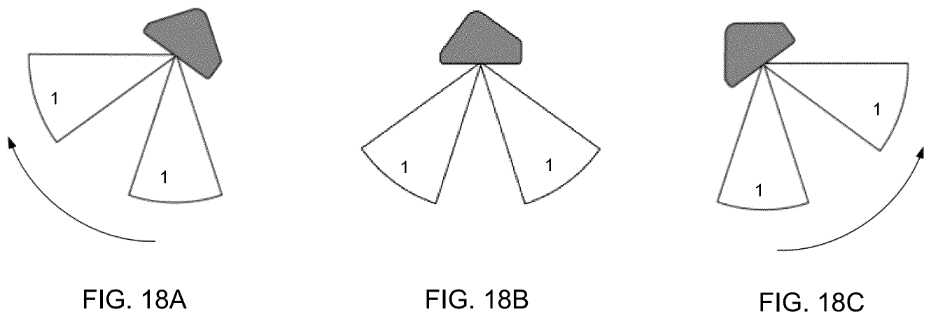

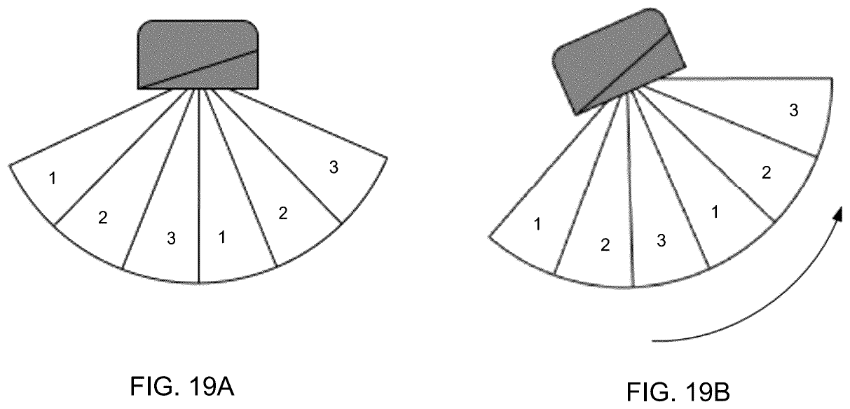

With reference to FIGS. 10-17 an alternative arrangement of adjustable sonar transducer pole 100 is presented. This alternative arrangement of the adjustable sonar transducer pole 100 presented in FIGS. 10-16 is similar to the configuration of adjustable sonar transducer pole 100 presented in FIGS. 1-9, with the primary difference being the adjustable sonar transducer pole 100 presented in FIGS. 10-16 has a telescoping pole 110 and alternative actuator mechanism. For this reason, unless specifically stated otherwise, all of the teaching and disclosure presented with respect to the arrangement presented in FIGS. 1-9 applies equally to the arrangement presented in FIGS. 10-17.

### Telescoping Pole 110

Conventional transducer poles have fixed lengths, which can make them difficult to transport and/or storage. In one or more arrangements, adjustable sonar transducer pole 100 includes a telescoping pole 110. Telescoping pole 110 is formed of any suitable size, shape, and design and is configured to expand and collapse in length between upper end 112 and lower end 114 to facilitate, more compact transportation and/or storage and/or to make adjustable sonar transducer pole 100 more adaptable for different applications and/or scenarios.

In one or more arrangements, as is shown, the telescoping pole 110 has a plurality of nesting segments including an exterior segment 310 and one or more interior segments 312 configured to nest within the exterior segment 310. In one or more arrangements, as is shown, exterior segment 310 and interior segment(s) 312 have a cylindrical tube shape. However, it is contemplated that exterior segment 310 and interior segment 312 of telescoping pole 110 may have various alternative shapes.

In one or more arrangements, as is shown, telescoping pole 110 includes one more connection mechanisms 320 to lock interior segment(s) 312 and exterior segment 310 together at a desired length of the telescoping pole 110. In one or more arrangements, as is shown, connection mechanisms 320 are clamps positioned at lower ends of exterior segment and/or interior segment(s) 312. However, the arrangements are not so limited. Rather, it is envisioned that various different arrangements may implement connection mechanism(s) 320 using various methods and/or means including but not limited to, for example, lock a, clips screws, bolts, clamps, and/or any other method or means for connecting.

### Cable Length Adjustment Assembly 400

In one or more arrangements, control arm 130 of adjustable sonar transducer pole 100 includes a cable length adjustment assembly 400. Cable length adjustment assembly 400 is formed of any suitable size, shape, and design, and is configured to adjust a length of cable 230 to facilitate extension/retraction of telescoping pole 110. In the arrangement shown, as one example, cable length adjustment assembly 400 includes a housing 402 connected to upper end 112 of telescoping pole 110, a spool 404, bias member 406, and axle 408 positioned within housing 402, and an actuator assembly 410, among other components.

### Housing 402

Housing is formed of any suitable size, shape and design and is configured to operably connect inward end 132 of control arm 130 with upper end 112 of telescoping pole 110 and house spool 404, bias member 406, axle 408, actuator assembly 410 and/or other components of cable length adjustment assembly 400. In one or more arrangements, as is shown, housing 402 has a cylindrical tube shaped main body 420 extending horizontally and a mount 422 extending downward from main body. Mount 422 is configured to connect with upper end 112 of telescoping pole 110. In this example arrangement, housing 402 has an opening 424 aligned with mount 412 to connect an interior of telescoping pole 110 with an interior of housing 402. In this example arrangement, housing 402 includes an end cap 426 configured to enclose one end of main body 420 of housing 402.

### Spool 404

Spool 404 is formed of any suitable size, shape and design and is configured to connect with indexer cable 230 and wind indexer cable 230 thereon when rotated in a first direction and unwind wind indexer cable 230 therefrom when rotated in a second direction. In the arrangement shown, as one example, spool 404 has a cylindrical shaped tube with flanges extending outward from ends of the tube. In this example arrangement, spool 404 has a plurality of holes 430 to facilitate mechanical connection with actuator assembly 410.

### Bias Member 406

Bias member 406 is formed of any suitable size, shape and design and is configured to apply a biasing force to spool 404 to cause spool to rotate and take up slack in indexer cable 230 when telescoping pole 110 is collapsed. In the arrangement shown, as one example bias member 406 is a torsion spring having a first end connected to spool 404 and a second end connected to end cap 426 of housing 402. As telescoping pole 110 is extended, indexer cable 230 is pulled and unwound from spool 404. As indexer cable 230 is unwound, spool 404 is rotated relative to end cap 426 and housing 202, which winds bias member 406 causes bias member 406 to apply a bias force to the spool. Conversely, when telescoping pole 110 is retracted, the bias force of bias member 406 causes spool 404 to rotate in the opposite direction and take up slack of indexer cable 230. However, the arrangements are not so limited. Rather, it is contemplated that various different arrangements bias member 406 may utilize various types of springs (e.g., torsion spring, compression spring, extension spring, or any other type of spring), stretchable bands, compressible materials, pneumatics, motors, and/or other method or means to apply a bias force to spool 404.

### Actuator Assembly 410

Actuator assembly 410 is formed of any suitable size, shape and design and is configured to selectively connect/disconnect first actuator 138 of control arm 130 with spool 404. In one or more arrangements, as is shown, actuator assembly 410 is configured to connect with an end of main body 420 of housing 402 opposite of end cap 426 and includes a second actuator 440. In one or more arrangements, second actuator 440 is a switch configured to move between a first position and a second position. In one or more arrangements, when moved to the first position, second actuator 440 causes one or more pins 444 (not shown) to engage holes 430 of spool 414 and thereby connect spool 414 with first actuator 138. When spool 414 is connected with the first actuator 138, spool 414 is prevented from rotating unless rotated by the first actuator 138. When spool is moved to the second position, second actuator 440 causes one or more pins 444 to disengage from holes 430 of spool 414, disconnecting spool 414 from the first actuator 138 and permitting spool to rotate freely to permit indexing cable 230 to be either wound onto or unwound from spool 414.

In the example arrangement shown in FIGS. 10-16, spool 404 is rotated to move indexing cable 230 for adjustment of position of sonar transducer 290 by rotating first actuator 138 about an axis A of control arm 130. In one or more arrangements, as is shown, first actuator 138 includes a button mechanism 442 configured to prevent the first actuator 138 from being rotated and/or from rotating spool 404 unless the button mechanism 442 is depressed by a user.

However, the arrangements are not so limited to these disclosed example actuators 138/440. Rather, it is contemplated that actuators 138/440 may be implemented using various indexed or friction shifters such as twist grip shifters, trigger shifters, thumb shifters, lever or stem shifters, knobs, sliders, or any other type of shifter or method or device for physical actuation.

From the above discussion it will be appreciated that the disclosed adjustable sonar transducer pole and related method of use, presented herein improves upon the state of the art and provides improved functionality over prior art systems. It will be appreciated by those skilled in the art that other various modifications could be made to the device without parting from the spirit and scope of this disclosure. All such modifications and changes fall within the scope of the claims and are intended to be covered thereby.

What is claimed:

1. An adjustable sonar transducer pole, comprising:
a pole having a first end and a second end;
a control arm operably connected to the first end of the pole;
an actuator operably connected to the control arm;
a transducer mount assembly operably connected to the second end of the pole;
wherein the transducer mount assembly is configured to operably connect a transducer head with the second end of the pole;
a cable extending from the actuator to the transducer mount assembly and/or the transducer head;
wherein movement of the control arm about a longitudinal axis of the pole causes the transducer head that is operably connected to the transducer mount assembly to be rotated about the longitudinal axis;
wherein movement of the actuator actuates the cable to rotate the transducer head that is operably connected to the transducer mount assembly about a second axis;
wherein the second axis extends at an angle relative to the longitudinal axis.

2. The adjustable sonar transducer pole of claim 1, wherein the second axis is a transverse axis of the pole.

3. The adjustable sonar transducer pole of claim 1, wherein the transducer mount assembly includes a portion configured to rotate relative to the pole.

4. The adjustable sonar transducer pole of claim 1, wherein the transducer head is configured to rotate while the transducer mount assembly remains stationary.

5. The adjustable sonar transducer pole of claim 1, further comprising the transducer head; wherein the connection between the transducer head and the second end of the pole permits the transducer head to rotate about the second axis.

6. The adjustable sonar transducer pole of claim 1, further comprising the transducer head; wherein the transducer head has a pivot point that allows the transducer head to pivot about the second axis.

7. The adjustable sonar transducer pole of claim 1, wherein the cable extends from the actuator through the pole to the transducer mount assembly and/or the transducer head.

8. The adjustable sonar transducer pole of claim 1, wherein the actuator is located at a position on the control arm so the movement of the actuator and the movement of the control arm can be performed simultaneously with one hand.

9. The adjustable sonar transducer pole of claim 1, wherein the actuator comprises a mechanism having predetermined indexed positions for controlling rotation of the transducer head about the transverse axis of the pole.

10. The adjustable sonar transducer pole of claim 1, further comprising a bias member configured to apply a bias force to the transducer mount assembly to return the transducer mount assembly to a home position when tension is released from the cable.

11. The adjustable sonar transducer pole of claim 1, wherein the actuator is an indexer-type a rotating grip shifter mechanism adapted for marine use.

12. The adjustable sonar transducer pole of claim 1, wherein the pole is configured to be operably connected with a boat structure or a set of legs to position the transducer head below water.

13. The adjustable sonar transducer pole of claim 1, wherein the pole is a cylindrical tube.

14. The adjustable sonar transducer pole of claim 1, wherein the pole is a telescoping pole.

15. An adjustable sonar transducer pole, comprising:
a telescoping pole having a first end and a second end;
wherein the telescoping pole is configured to extend and retract in length between an extended length and a collapsed length;
a control arm operably connected to the first end of the telescoping pole;
an actuator operably connected to the control arm;
a transducer mount assembly operably connected to the second end of the telescoping pole;
wherein the transducer mount assembly is configured to operably connect with a transducer head;
a cable extending through the telescoping pole from the actuator to the transducer mount assembly and/or the transducer head;
wherein movement of the control arm about a longitudinal axis of the telescoping pole causes the transducer mount assembly to rotate about the longitudinal axis;
wherein movement of the actuator actuates the cable to cause the transducer head to rotate the about a second axis; and
wherein the second axis extends at a angle relative to the longitudinal axis.

16. The adjustable sonar transducer pole of claim 15, wherein the transducer mount assembly is configured to pivot relative to the telescoping pole.

17. The adjustable sonar transducer pole of claim 15, wherein the second axis is a transverse axis of the pole.

18. The adjustable sonar transducer pole of claim 15, wherein the actuator is located at a position on the control arm so the movement of the actuator and the movement of the control arm can be performed simultaneously with one hand.

19. The adjustable sonar transducer pole of claim 15, further comprising an electronics wire extending through the pole and connected to the transducer head.

20. The adjustable sonar transducer pole of claim 15, further comprising, a cable length adjustment assembly coupled to an upper end of the cable;
wherein the cable length adjustment assembly includes a spool and is configured to unspool the cable as telescoping pole is extended and spool up the cable as telescoping pole is extended is collapsed.

21. The adjustable sonar transducer pole of claim 20, wherein the cable length adjustment assembly includes a bias member configured to apply a bias force to the cable so as to cause the spool to rotate and spool up the cable in absence of an opposing force.

22. The adjustable sonar transducer pole of claim 20, wherein the cable length adjustment assembly includes a bias member configured to apply a bias force to the cable so as to cause the spool to rotate and spool up the cable in absence of an opposing force; and
further comprising a second actuator;
wherein when the second actuator is in a first position the second actuator causes the cable length adjustment assembly to unspool the cable as telescoping pole is extended and spool up the cable as telescoping pole is extended is collapsed;
wherein when the second actuator is in a second position the second actuator causes the cable length adjustment assembly prevent the cable from being spooled up or unspooled without actuation of the first actuator.

23. The adjustable sonar transducer pole of claim 15, wherein the cable is configured to coil up when the telescoping pole is retracted in length to the collapsed length.

24. The adjustable sonar transducer pole of claim 15,
wherein the actuator comprises a grip shifter mechanism having predetermined indexed positions for controlling rotation of the transducer mount assembly about the transverse axis of the pole;
wherein the predetermined indexed positions correspond to predetermined increments of rotation across portions of a 180 degree range of rotation.

25. The adjustable sonar transducer pole of claim 15, wherein the pole is configured to be operably connected with a boat structure or a set of legs to position the transducer head below water.
